(19) United States
(12) Patent Application Publication
(10) Pub. No.: US 2012/0141308 A1
(43) Pub. Date: Jun. 7, 2012

(54) Polymeric Pump Parts

(76) Inventors: Rajesh K. Saini, Cypress, TX (US); Fen Liang, Crpress, TX (US); David M. Stribling, Duncan, OK (US)

(21) Appl. No.: 13/310,848

(22) Filed: Dec. 5, 2011

Related U.S. Application Data
(60) Provisional application No. 61/420,624, filed on Dec. 7, 2010.

(51) Int. Cl. F04B 47/00; C08L 75/04; B29C 43/02; B82Y 30/00

(52) U.S. Cl. 417/452; 264/331.19; 524/590; 977/742; 977/773; 977/811

(57) ABSTRACT

Polymeric and polymeric composite parts for pumps and a method of manufacturing same are disclosed. More specifically, a valve insert comprising a polymeric seal sized to fit on an outside diameter of a valve closure member for a plunger pump; a pressure packing element ring for a plunger on a plunger pump; and a pressure packing element ring for a push rod on plunger of a plunger pump, each of said articles being formed from a naphthalene-1,5-diisocyanate (NDI) based polyurethane component and an extender.

### CROSS-REFERENCE TO RELATED APPLICATION

This application claims the benefit under 35 U.S.C. §119(e) of U.S. patent application Ser. No. 61/420,624, entitled “Polymeric Pump Parts,” filed Dec. 7, 2010, which is incorporated herein by reference in its entirety.

### TECHNICAL FIELD

This disclosure relates to polymeric and polymeric composite parts for pumps and other equipment used in oil and gas drilling and production operations. More specifically, this disclosure is about elastomer and elastomeric composite parts for pumps and other equipment and seals used in oil and gas drilling and production operations.

### BACKGROUND

High pressure pumps are used in many aspects of drilling and production operations in the oil and gas industry. Some parts of the pumps (e.g., elastomeric inserts on plunger), are especially susceptible to wear especially when pumping abrasive or corrosive fluids used in well completions and stimulation work often referred to in the industry as “hydraulic fracturing” or “frac jobs” or recently “fracking” by some news media reports.” “Fracturing” is an abbreviation for a stimulation treatment wherein fluid (with or without proppant) is pumped at high pressures into downhole geologic formations to enhance the production of hydrocarbons from the treated geologic formation. Polyurethane materials have been used for valve inserts and pressure packing in pumps used in the oil and gas industry. These commodity polyurethane parts are used in pumps due to their better abrasion resistance, resilience, dynamic load bearing capacity, toughness and other mechanical properties. These parts undergo mechanical wear under extreme conditions of stress and need to be frequently changed. The frequent change of parts leads to loss in productivity due to equipment downtime. A need exists for enhanced polymeric or elastomeric materials and polymeric or elastomeric composites that have better chemical resistance, mechanical toughness, abrasion resistance, resilience, dynamic load, and other mechanical properties that result in increased life for the polymeric pump parts.

### SUMMARY

This document discloses high performance naphthalene-1,5-diisocyanate (NDI) based polyurethane components that have been determined to have qualities superior to other polyurethane materials when used for pumps and other tools used in the oil and gas drilling and production industry. Components prepared with the polymeric materials of the present disclosure have excellent mechanical, dynamic load, abrasion resistance, resilience and shear properties. Also, these components will last longer and will need less frequent replacement. Additionally, 1,5-naphthalene diisocyanate/polyester based elastomers show hydrolysis resistance that is superior to diphenylmethane diisocyanate (MDI) based polyurethane. These polymeric materials are suitable for applications where high abrasion resistance, good chemical resistance and resilience properties are desired. For example, the NDI based polyurethane is suitable for “fracturing” pump valve inserts. In this process the insert will encounter a dynamic loading of 0 to 20,000 psi with sand laden fluids and highly corrosive chemicals (e.g., 15% HCl or gels with pH of >12). Present MDI based polyurethane has inferior properties to the new polymeric materials of this disclosure, in terms of life of the inserts, chemical resistance and mechanical properties.

The disclosed polymeric materials give superior dynamic load, abrasion, resilience and chemical resistance properties in comparison to previous polyurethane elastomers. Also, composites of the polymeric materials can be formed by mixing nanofibers, fibers and particles in the urethane to enhance its mechanical properties.

Polymeric components prepared from the NDI based polyurethane of the present disclosure can have the following advantages:

1. Superior mechanical properties such as high dynamic break load, Bayshore resilience and abrasion resistance.

2. Superior chemical resistance properties especially in NDI ether based polyurethane.

3. Due to superior mechanical and chemical resistance properties the components made from these enhanced polymeric materials will last longer and there will be less need to replace the parts. This increased life will result in cost savings for replacement parts. However, much larger economic benefits are generated by the reduction in downtime due to servicing prior art pumping equipment or replacing the worn prior art urethane components.

4. Composites of enhanced NDI, MDI and TDI based polyurethane may be used to further improve performance properties of the polymeric parts.

Additionally, this document discloses naphthalene-1,5-diisocyanate (NDI) based polyurethane, TDI based polyurethane, MDI based polyurethane and other polyurethanes composites/nanocomposites for use in pumps, parts and other tools used in the oil and gas industry. The polyurethane composites of this invention comprise fibers (e.g., carbon fibers, glass fibers, Kevlar fibers, ceramic fibers etc.), nanofibers (e.g., carbon nanotubes, quartz fibers, nanometallic fibers etc.) and nanoparticles (e.g., TiO₂, platelet nanoclay, alumina nanoparticles, carbon etc.) to enhance the mechanical properties of the components. The composite materials enhance the toughness and other mechanical properties of the polyurethane. It is believed that nanofibers incorporated in the composite help distribute the stress and prevent the propagation of the crack in the material.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a partial cut away perspective of a first embodiment of a plunger pump illustrating some of the polymeric pump parts of this disclosure;

FIG. 2. is a cross-section view of the fluid end of the plunger pump of FIG. 1 illustrating some of the polymeric parts of this disclosure ; and

FIG. 3 is an exploded perspective view of a pump plunger seal used in the pump of FIG. 2.

FIG. 4 is a graph summarizing the pump valve insert wear test.

Like reference symbols in the various drawings indicate like elements.

### DETAILED DESCRIPTION

Elastomeric Components

In oil and gas exploration and production applications there is a need for enhanced polymeric components for pumps and other equipment that have superior abrasion resistance, chemical resistance and resilience properties. These needs are satisfied by the enhanced polyurethane based components of this disclosure which show good abrasion resistance, chemical resistance and resilience properties.

In the past, diphenylmethane diisocyanate (MDI) and toluene diisocyanate (TDI) based polyurethane has been extensively used in the industry due to the ease of their molding. The NDI based polyurethane materials of this disclosure have not received much attention due to difficulty in processing of these polymers. Recently, a new method was developed to easily process NDI based polyurethane by Baulé USA. The enhanced polymeric materials of this disclosure are shown to have superior mechanical and resilience properties over conventional MDI or TDI based polyurethane.

Exemplary Uses of Elastomeric Components in a High Pressure Pump

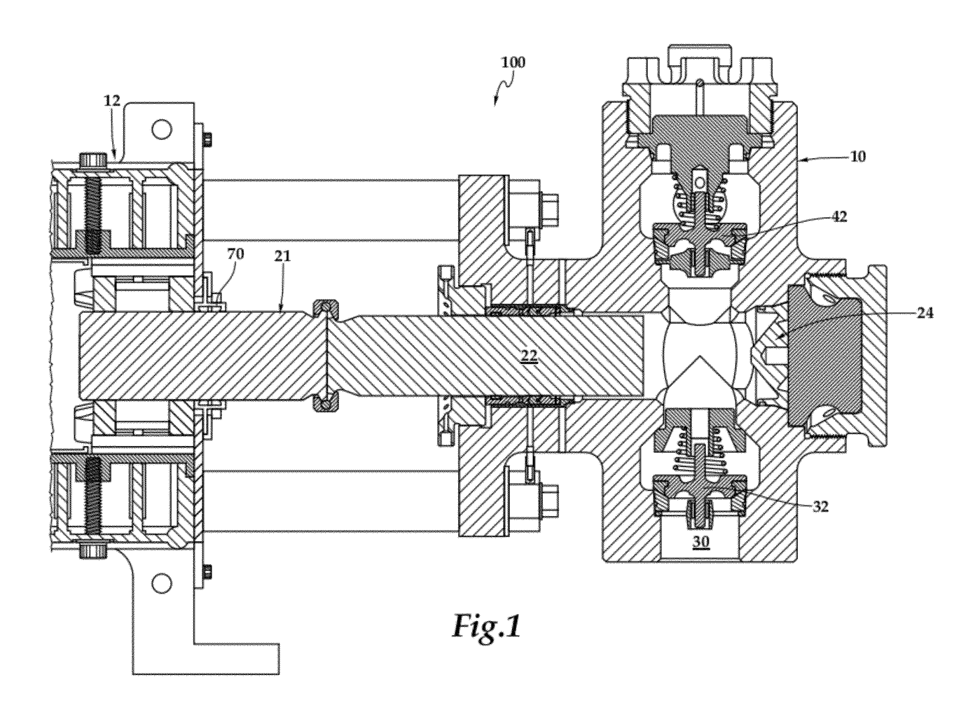

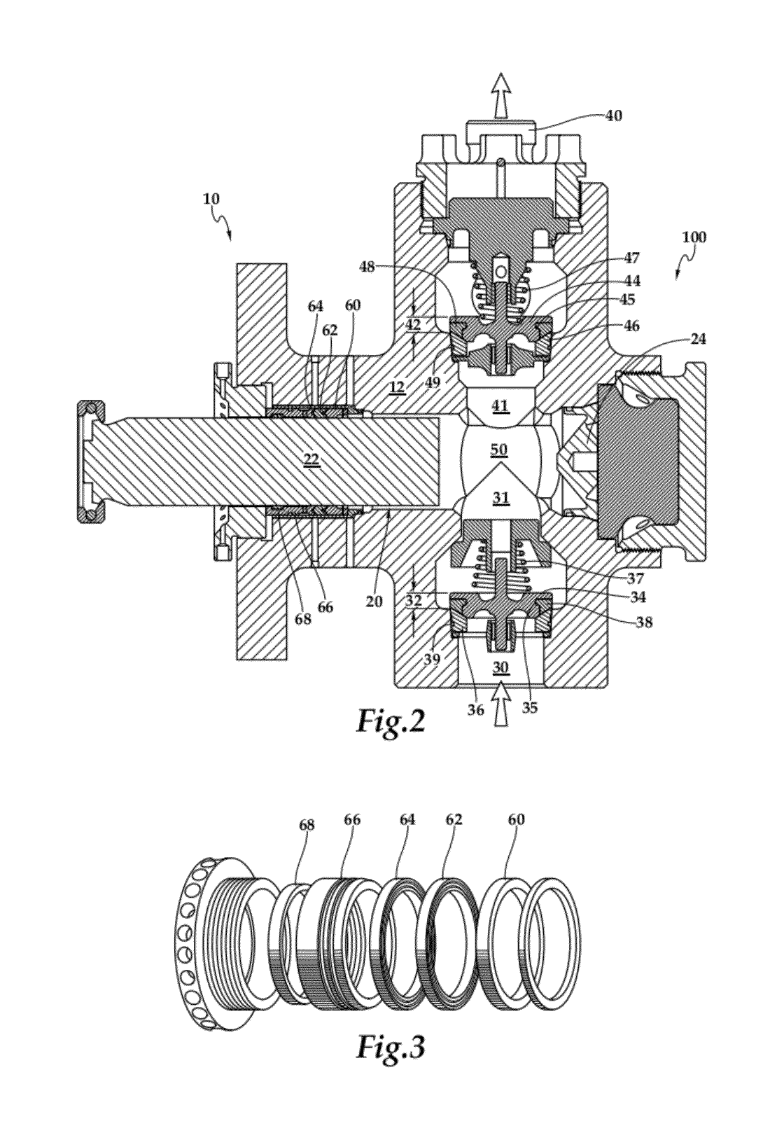

As discussed above, the elastomeric components of this disclosure may be used as components in high pressure pumps. Referring now to FIGS. 1 and 2, wherein by way of example, but not by way of limitation, is illustrated a fluid end 10 of a high pressure plunger pump 100 in which the elastomeric components of this disclosure may be used. This particular embodiment is manufactured by applicant's assignee, Halliburton, and is available as a Model Q10. By way of example and not by way of limitation, other pumps on which the enhanced polymeric materials of this disclosure may be used are Halliburton pump models nos. HT-400, HT-2000, Grizzly and Bearcat. As will be understood by those familiar with pumps, use of the enhanced polymeric materials and composites polymeric materials of this disclosure may be used on known plunger pumps manufactured by other parties and/or plunger pumps developed by Applicant and other parties in the future.

The pump 100 includes a power end section 12 and a fluid end section 10. The power end section 12 includes a mechanical driver (not shown but known in the art) connected to a push rod 21 at a first end of the push rod and a second end of the push rod connected to a plunger 22. A push rod wiper seal 70 is disposed around push rod 21. The fluid end section 10 includes at least one cylinder 20 and a plunger 22 slidably disposed in the at least one cylinder, and a cylinder head cover 24. An inlet bore 30 is fluidly connected to the cylinder 20, said inlet bore having a suction valve 32 disposed in the inlet bore. The suction valve includes a suction valve closure member 34 and a suction valve seat 36. The pump 100 further includes an outlet bore 40 fluidly connected to the cylinder 20. The outlet bore having a discharge valve 42 disposed therein, the discharge valve includes a discharge valve closure member 44 and a discharge valve seat 46. The pump includes at least one valve insert 38, 48 disposed on at least one valve closure member 34 and 44 respectively. The valve insert member 38, 48 comprises an elastomeric seal sized to fit in a ring groove 35, 45 disposed on an outside diameter of the valve closure member 34, 44. The valve insert 38, 48 being formed from a naphthalene-1,5-diisocyanate (NDI) based polyurethane component and a 1,4-butane diol extender.

The cylinder bore(s) 20 of the fluid end 10 each contain the plunger 22 and pressure packing 60.

In operation, the power end 12 moves the reciprocating plunger(s) 22. As the plunger 22 is withdrawn from a cylinder bore(s) 20 in the fluid end section 10, a partial vacuum is created. The suction valve 32 is drawn up and away from its seat 36, allowing fluid to enter a fluid chamber 50 in the fluid end 10. At the same time, fluid already in the fluid chamber 50 moves in to fill the space where the plunger(s) 22 was in the cylinder(s) 20. The fluid chamber 50 includes the distal end of the cylinder(s) 20 and a portion 31 of the inlet bore 30 which is located downstream of the suction valve 31 and a portion 41 of the outlet bore 40 which is located upstream of the discharge valve 42.

As the plunger re-enters the fluid end section 10, the fluid is pressurized. Fluid would go out the way it entered the chamber 50, but the suction valve 32 moves into contact with the seat 36. As pressure increases, the fluid pressure forces the discharge valve 42 to open.

The discharge valve 42 moves up off its seat 46 and the fluid is expelled from the chamber 50. Loss of pressure inside the chamber and the force of the discharge valve spring 47 moves the discharge valve 42 down to form a seal with its seat 46, wherein the cycle begins again.

The insert 48 forms the initial seal against pump pressure as the discharge valve 42 moves down against the valve seat 46.

Valves 32 and 42 are machined from alloy steel and are carburized. They may be treated with a hot chemical that builds up the carbon content of the metal to a shallow depth. The surface is hard and long-wearing but the core remains soft and ductile.

In the illustrated embodiment, the seats 36 and 46 are hardened (carburized) which offers long life when pumping abrasive fluids. The outside diameter (O.D.) of the valve seat 36 and 46 is tapered. It is wedged into a seat bore of the fluid end section. An O-ring 39 and 49 on the O.D. of the respective seats 36 and 46 helps reduce erosion by the fluids being pumped.

Referring to FIGS. 2 and 3, pressure packing elements 60, 62, 64, and 66 prevents fluid from getting out around the moving plunger 22. The pressure packing elements are shaped like a ring and have a “V” shaped cross-section. Squeezing the packing elements decreases height and increases the width of the “V.” When this happens, the packing expands and presses harder against the bore 20 and against the plunger 22, forming a seal. A “short stack” packing arrangement uses a homogeneous header ring 60 and one ring of “double stack” (or double thick) V-type packing 62. This is followed by a thin brass back-up ring 64 and a steel carrier 66. The steel carrier 66 holds a plunger lube seal 68.

In prior art embodiments the header ring 60 is formed of NBR or Urethane. NBR is most commonly used in prior art pumping services. Urethane was originally used to prevent explosive decompression w/CO₂ pumping. Urethane has gained popularity with other oil field services, including cementing. Urethane is a more expensive alternative.

In prior art embodiments the push rod wiper seal 70 is frequently formed of urethane. However, urethane formed push rod seals suffer accelerated wear when proppant in the pumped fluid collects on the push rod during long pumping jobs, especially long “frac” jobs. The surface of the push rod has a lubricant film on it which attracts dust and proppant. The life of the push rod may be decreased due to trapped contaminant in the wiper seal 70 wearing against the surface of the push rod. The wiper seal 70 formed from the polymeric material or polymeric composite of the present disclosure can increase the push rod life by reducing wear on the push rod by reducing the amount of embedded contaminant (e.g., frac proppant) in the wiper seal.

Exemplary Materials for Manufacturing the Enhanced Polymeric Parts for a Pump

NDI-based polyurethane prepolymer: ND3941 (old name: Desmodur® 15S41, polyester), NT3732 (old name: Desmodur® 15E32, polyether) are available from Baulé USA, LLC. Extender: 1,4-butane diol is available from Aldrich. It will be understood that other extenders may be used in the preparation of enhanced polymeric parts used in the present disclosure. All chemicals were used as received. Inserts were molded using the recipes which were provided by Baulé USA and is listed in Table 1.

TABLE 1
Recipes to make neat NDI based polyurethanes 1 and 2

| | |
|---|---|
| Prepolymer (PHR) | Extender (PHR) |

| Recipe | NT3732 | ND3941 | 1,4-Butane diol |
|---|---|---|---|
| 1 | 100 | N/A | 2.98 |
| 2 | N/A | 100 | 3.82 |

Below is compression deflection test data for various NDI-polyester polyurethane materials reinforced with various fibers and particles. A composite of NDI based polyurethane may improve the mechanical properties of the base polymer. Fibers, nanofibers and particles may be added to achieve superior properties. A few types of reinforced NDI based polyurethane composite buttons were molded in the lab by mixing Desmodur® pre-polymer (NT3732 and ND3941), 1,4-butane diol and fillers. The mixing recipes were listed in Table 2. Air release agent DOW CORNING® DC Antifoam 1500 was used to release air bubbles generated during the mixing procedure. The mixture was poured into a sample mold (8″×8″ plate with 20 holes of 1.15″ diameter and 0.50″ thickness) and cured at 110° C., 1000 psi in a Carver Press for 30 minutes, demolded the sample, and then post cured them for 24 hours at 110° C. The material was then allowed to sit at room temperature for three weeks before any testing was done on the samples. The compression test was performed using ASTM D 575. The recipes and compressive strength were recorded in Table 3.

TABLE 2
Recipes for making reinforced NDI based polyurethanes 3 to 18

| | | Extender | | | | | | | | |
|---|---|---|---|---|---|---|---|---|---|---|
| | Prepolymer | (PHR) | | Fillers | | | | | | |
| | (PHR) | 1,4-Butane | Air Release | Glass | ThermalGraph | | Alumina | Ceramic | Carbon | Carbon |
| Recipe | ND3941 | diol | Agent (PHR) | Fiber | DKD | Kevlar | Powder | Fiber | Fiber | Black |
| 3 | 100 | 3.82 | 0.05 | 10 | | | | | | |
| 4 | 100 | 3.82 | 0.05 | 15 | | | | | | |
| 5 | 100 | 3.82 | 0.05 | 20 | | | | | | |
| 6 | 100 | 3.82 | 0.05 | | 5 | | | | | |
| 7 | 100 | 3.82 | 0.05 | | 10 | | | | | |
| 8 | 100 | 3.82 | 0.05 | | 13 | | | | | |
| 9 | 100 | 3.82 | 0.05 | | | 1 | | | | |
| 10 | 100 | 3.82 | 0.05 | | | 1.96 | | | | |
| 11 | 100 | 3.82 | 0.05 | | | | 10 | | | |
| 12 | 100 | 3.82 | 0.05 | | | | | 5 | | |
| 13 | 100 | 3.82 | 0.05 | | | | | 10 | | |
| 14 | 100 | 3.82 | 0.05 | | | | | | 1 | |
| 15 | 100 | 3.82 | 0.05 | | | | | | 2 | |
| 16 | 100 | 3.82 | 0.05 | | | | | | 2.78 | |
| 17 | 100 | 3.82 | 0.05 | | | | | | | 5 |
| 18 | 100 | 3.82 | 0.05 | | | | | | | 8 |

TABLE 3
Summary of compression test data and hardness of polyurethane materials made from Recipe 0 to 18

| | Material | | | psi @ Compression Deflection | | | | Hardness |
|---|---|---|---|---|---|---|---|---|
| Recipe | (Polyurethane) | Filler | PHR | 10% | 20% | 25% | 40% | (shore D) |
| 0 | MDI based polyester | N/A | N/A | 483 | 824 | 1024 | 1949 | 42 |
| | (current product) | | | | | | | |
| 1 | NT3732 | N/A | N/A | 302 | 560 | 713 | 1383 | 40 |
| 2 | ND3941 | N/A | N/A | 451 | 797 | 991 | 1845 | 41 |
| 3 | ND3941 | Glass Fiber | 10 | 477 | 852 | 1071 | 2166 | 45 |
| 4 | ND3941 | Glass Fiber | 15 | 490 | 879 | 1104 | 2292 | 45 |
| 5 | ND3941 | Glass Fiber | 20 | 491 | 890 | 1128 | 2394 | 47 |
| 6 | ND3941 | ThermalGraph DKD | 5 | 487 | 906 | 1153 | 2500 | 47 |
| 7 | ND3941 | ThermalGraph DKD | 10 | 590 | 1102 | 1424 | 3507 | 48 |
| 8 | ND3941 | ThermalGraph DKD | 13 | 547 | 1006 | 1297 | 3249 | 50 |
| 9 | ND3941 | Kevlar | 1 | 452 | 785 | 986 | 2076 | 43 |
| 10 | ND3941 | Kevlar | 1.96 | 491 | 860 | 1084 | 2291 | 46 |
| 11 | ND3941 | Alumina Powder | 10 | 434 | 786 | 992 | 1971 | 42 |
| 12 | ND3941 | Ceramic Fiber | 5 | 506 | 1006 | 1314 | 3023 | 48 |
| 13 | ND3941 | Ceramic Fiber | 10 | 514 | 1031 | 1364 | 3549 | 50 |
| 14 | ND3941 | Carbon Fiber | 1 | 453 | 878 | 1128 | 2514 | 46 |
| 15 | ND3941 | Carbon Fiber | 2 | 536 | 1024 | 1334 | 3155 | 49 |
| 16 | ND3941 | Carbon Fiber | 2.78 | 477 | 914 | 1211 | 3121 | 52 |
| 17 | ND3941 | Carbon Black | 5 | 439 | 785 | 990 | 1981 | 43 |
| 18 | ND3941 | Carbon Black | 8 | 476 | 840 | 1056 | 2148 | 45 |

Typical Properties of Fillers:
a) Glass Fiber: was purchased from Fibre Glast Developments Corporation. The average length is 1/32″ (˜80 microns) with 10 microns in diameter. The aspect ratio is 8:1. Other glass fibers can also be used and one skilled in the art may know the dimensions required for the reinforcement of rubbers.
b) ThermalGraph DKD: was purchased from Cytec Industries Inc. ThermalGraph DKD is a pitch-based high thermal conductivity fiber developed for thermal management applications. The fiber has a longitudinal thermal conductivity of 400-650 W/mK, which is 50% higher than copper. The average length is 200 microns (length distribution: <20% less than 100 microns and <20% greater than 300 microns) and 10 microns in diameter.

Tensile strength is 200 ksi and tensile modulus is 100-120 Msi. Other thermal graph or heat conductive fibers can also be used and one skilled in the art may know the dimensions required for the reinforcement of rubbers.
c) Kevlar (pulp): Kevlar Para-aramid fiber was purchased from DuPont with an average length of 1 mm (range: 0.8 mm˜1.3 mm). Other Kevlar can also be used and one skilled in the art may know the dimensions required for the reinforcement of rubbers.
d) Ceramic Fiber: Nextel™ ceramic fiber 312 Style AC-8 was purchased from 3M with an average length of ⅛″. Other ceramic fibers can also be used and one skilled in the art may know the dimensions required for the reinforcement of rubbers.
e) Carbon Fiber: chopped carbon fiber AS1925 was purchased from HEXTOW with average length of ⅛″. Other carbon fibers can also be used and one skilled in the art may know the dimensions required for the reinforcement of rubbers.
f) Carbon Black: Carbon black Rayon 790 was from Columbian.

The compression test data in Table 3 indicates that the Recipe 4 (reinforced with glass fiber), 7 (reinforced with ThermalGraph), 10 (reinforced with Kevlar) and 15 (reinforced with carbon fiber) provide superior results over the base NDI control polymer (Recipe 2). Inserts with recipe 2 (control) and the four reinforced recipes (4, 7, 10 and 15) were molded into pump insert for in-house mechanical testing.

Due to the high viscosity occurred from the mixing in Recipe 10 and 15, filler amounts in the molded inserts were lower down to 0.8 PHR Kevlar (Recipe 20) and 0.7 PHR carbon fiber (Recipe 19), respectively (Table 4).

TABLE 4
Recipes to make inserts 19 and 20.

| | | Extender | | | |
|---|---|---|---|---|---|
| | Prepolymer | (PHR) | | Fillers | |
| | (PHR) | 1,4-Butane | Air Release | Carbon | |
| Recipe | ND3941 | diol | Agent (PHR) | Fiber | Kevlar |
| 19 | 100 | 3.82 | 0.05 | 0.7 | |
| 20 | 100 | 3.82 | 0.05 | | 0.8 |

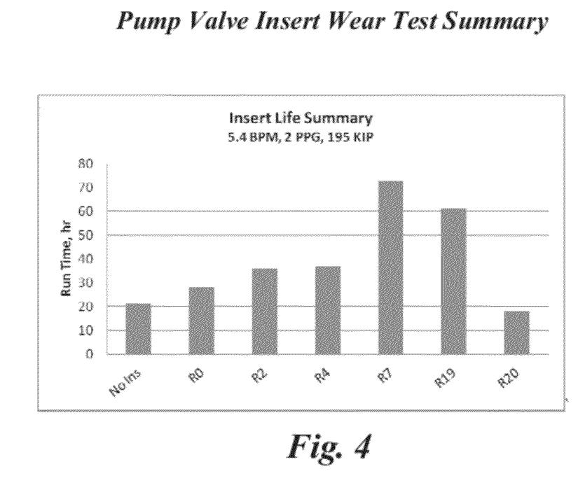

FIG. 4 Pump Valve Insert Wear Test Summary

Five different valve insert recipes (Recipe 2, 4, 7, 19 and 20) were submitted for wear life testing on the Pump Valve Test Fixture at Building 719, Duncan Technology Shop and Labs. The new recipes will be compared to the standard valve insert materials currently used (MDI based polyurethane, Recipe 0 in Table 3) in Halliburton well service pumps.

Test Condition—

Run a minimum of two samples of each recipe to a maximum wear condition of 0.04 inches under a load of 195,000 lb, in a circulation of 2 lb/gal sand slurry, flowing at 5.4 bbl/min.

Discussion—

The Pump Valve Test Fixture has been developed to test the valve components of Halliburton pumps under near-actual operating conditions.

A hydraulic cylinder is used to raise and lower the valve/insert assembly, mimicking the reciprocating action of the pump valve. The cylinder presses the valve/insert assembly against a valve seat, and applies a load equivalent to the load developed by pumping pressure in operation.

As the valve assembly reciprocates, a water/sand slurry mixture is circulated through the test chamber to provide an erosive environment. The combination of the erosive media, and the load applied to the valve assembly, wear the valve components in a manner similar to valves operated in the field.

The control system monitors the displacement of the cylinder, and the force applied to the valve assembly. The displacement and force are recorded at regular intervals until the maximum displacement is reached, and the maximum load achieved at this displacement drops below the target level, indicating the valve assembly has reached the predetermined wear limit. This limit has been determined to be 0.04 inches from historical maintenance data.

The load of 195,000 lb is equivalent to a pump pressure of 9,000 psi, which is the average pressure pumps using this size of valve operate in the field.

The previously described wear test system has proven that it can perform controlled wear tests in a shorter time span than field trials alone. It allows fast testing of several candidate materials, and only those promising materials are then sent to field trials.

Note: “No Ins” was a test run without inserts to determine baseline metallic wear with the slurry mixture. “R0” is the current materials used in Halliburton pumps (MDI based polyurethane). “R 2” refers to Recipe 2; “R 4” to Recipe 4; “R 7” to Recipe 7; “R 19” to Recipe 19; “R 20” to Recipe 20.

FIG. 4 showed that 36 hours of life for Recipe 2 insert in the in-house mechanical testing, which is approximately a 29% increase comparing to current insert used in Halliburton pumps (28 hours).

The promising lab results of Recipe 2 in the test program led to sending samples to the field for further testing. The field experienced a three to five times life increase over the best current valve insert material (R0 in FIG. 4) under the same condition.

Recipe 4 insert was NDI based polyester material (Recipe 2) reinforced with 15 PHR glass fiber. It showed 36.5 hours of insert life in the in-house mechanical testing, which is similar to non-reinforced Recipe 2 insert (FIG. 4).

Recipe 7 insert was NDI based polyester material (Recipe 2) reinforced with 10 PHR ThermalGraph. It showed 72.5 hours of insert life in the in-house mechanical testing, which is approximately a 100% increase in life over Recipe 2 (FIG. 4).

Recipe 19 insert was NDI based polyester material (Recipe 2) reinforced with 10.7 PHR carbon fiber. It showed 50 hours of insert life in the in-house mechanical testing, which is approximately a 39% increase in life over Recipe 2 (FIG. 4).

Recipe 20 insert was NDI based polyester material (Recipe 2) reinforced with 0.8 PHR Kevlar fiber. It experienced accelerated wear, resulting in life less than the Recipe 2 and even the baseline “No Insert” test (FIG. 4).

Based on lab results, Recipes 7 (reinforced with ThermalGraph) and 19 (reinforced with carbon fiber) will be submitted to field trials to determine life under actual operating conditions.

Method of Manufacture of Composite Enhanced Polymeric Parts of a Pump

1. Valve inserts without fillers presented:

The Desmodur® pre-polymer (NT3732 or ND3941) was melted in a convection oven at 70° C. for 16-24 hours. Then desired amount of prepolymer was transferred to a dry plastic can with lid (suitable for SpeedMixer™ by Hauschild) and placed in an oven at 95° C. Slowly apply vacuum and degas prepolymer until no bubbles are seen. Weight about the recommended amount of 1,4-butane diol (extender) into a dry container. Place the container in a vacuum oven maintained at 60° C. and degas the material until no bubbles are seen. Clean the valve insert mold, spray lightly with Silicone Mold Release and place in a convection oven maintained at 110° C. Ensure the prepolymer and extender at the desired processing temperatures, and then move the cans to the fume hood using heat-resistant gloves. Add the extender to the pre-polymer. If using a SpeedMixer™ by Hauschild (DAC 400 FVZ: speed 800 rpm to 2750 rpm), close plastic container with lid, place in a High Speed Mixer and mix for 2 minutes. Remove lid and pour reacting mixture into the pre-heated mold. Place mold between the Carver® Press maintained at 110° C. and 1000 psi for 30 minutes and then demold the part. Place the molded part(s) into the oven and postcure them for 24 hours at 110° C. Remove the molded part(s) from the oven and allow them to mature at 25° C. and 50% RH for a period of 3 weeks before testing for physical properties or putting parts in the application.

2. Valve inserts reinforced by fillers:

The Desmodur® pre-polymer (NT3732 or ND3941) was melted in a convection oven at 70° C. for 16-24 hours. Then desired amount of prepolymer and fillers were transferred to a dry plastic can with lid (suitable for SpeedMixer™ by Hauschild) and placed in an oven at 95° C. for 20 minutes. Small amount of air release product might be added to help remove air bubbles. Place the container (with lid) into the SpeedMixer^{TM and mix for} 2 minutes. If bubbles are still present in the mixture, repeat the heating and spin in the SpeedMixer™ steps until no bubbles are seen. Weight about the recommended amount of 1,4-butane diol (extender) into a dry container. Place the container in a vacuum oven maintained at 60° C. and degas the material until no bubbles are seen. Clean the valve insert mold, spray lightly with Silicone Mold Release and place in a convection oven maintained at 110° C. Ensure the prepolymer and extender at the desired processing temperatures, and then move the cans to the fume hood using heat-resistant gloves. Add the extender to the pre-polymer. If using a SpeedMixer™ by Hauschild (DAC 400 FVZ: speed 800 rpm to 2750 rpm), close plastic container with lid, place in a High Speed Mixer and mix for 2 minutes. Remove lid and pour reacting mixture into the pre-heated mold. Place mold between the Carver® Press maintained at 110° C. and 1000 psi for 30 minutes and then demold part. Place the molded part(s) into the oven and postcure them for 24 hours at 110° C. Remove the molded part(s) from the oven and allow them to mature at 25° C. and 50% RH for a period of 3 weeks before testing for physical properties or putting parts in the application.

A number of embodiments of the invention have been described. Nevertheless, it will be understood that various modifications may be made without departing from the spirit and scope of the invention.

1. A pump including a fluid end section comprising:
at least one cylinder and a plunger slidably disposed in the at least one cylinder;
an inlet bore fluidly connected to the cylinder, said inlet bore having a suction valve disposed therein, said suction valve including a suction valve closure member and a suction valve seat; and
an outlet bore fluidly connected to the cylinder, said outlet bore having a discharge valve disposed therein, said discharge valve including a discharge valve closure member and a discharge valve seat; and
at least one valve insert disposed on at least one valve closure member, said valve insert member comprising a polymeric seal sized to fit on an outside diameter of the valve closure member, and said valve insert being formed from a compound comprising a naphthalene-1,5-diisocyanate (NDI) based polyurethane component and an extender.

2. The pump of claim 1 wherein the valve insert is formed from a composite selected from the group consisting of MDI or TDI or NDI based polyurethane combined with fibers selected from the group consisting of carbon fibers and thermally conductive fibers.

3. The pump of claim 1 wherein the valve insert is formed from a composite selected from the group consisting of MDI or TDI or NDI based polyethylene polyurethane combined with fibers selected from the group of ceramic fibers, glass fibers and Kevlar fibers.

4. The pump of claim 1 wherein the valve insert is formed from a composite selected from the group consisting of MDI or TDI or NDI based polyurethane combined with nanofibers selected from the group consisting of carbon nanotubes and nanometallic fibers.

5. The pump of claim 1 wherein the valve insert is formed from a composite selected from the group consisting of MDI or TDI or NDI based polyurethane combined with nanoparticles selected from the group consisting of TiO₂, platelet nanoclay, and carbon.

6. A valve insert comprising a polymeric seal sized to fit on an outside diameter of a valve closure member for a plunger pump, said valve insert being formed from a naphthalene-1,5-diisocyanate (NDI) based polyurethane component and an extender.

7. The article of claim 6 wherein the NDI based polyurethane component is formed by reacting polyester polyol, polyether polyol or, polycarbonate polyol with NDI.

8. The valve insert of claim 6 comprising a composite selected from the group consisting of MDI or TDI or NDI based polyurethane combined with fibers selected from the group consisting of carbon fibers and thermally conductive fibers.

9. The valves insert of claim 6 comprising a composite selected from the group consisting of MDI or TDI or NDI based polyurethane combined with fibers selected from the group consisting of ceramic fibers, glass fibers and Kevlar fibers.

10. The valve insert of claim 6 comprising a composite selected from the group consisting of MDI or TDI or NDI based polyurethane combined with nanofibers selected from the group consisting of carbon nanotubes and nanometallic fibers.

11. The valve insert of claim 6 wherein the extender is 1,4-butane diol.

12. The valve insert of claim 6 comprising a composite selected from the group consisting of MDI or TDI or NDI based polyurethane combined with nanoparticles selected from the group consisting of TiO₂, platelet nanoclay, and carbon.

13. A method of manufacturing an article comprising a polymeric valve insert sized to fit on an outside diameter of a valve closure member for a plunger pump, said method comprising:
melting a predetermined amount of a naphthalene-1,5-diisocyanate (NDI) based polyurethane component;
applying a vacuum to degas the melted NDI component;
applying a vacuum to degas a predetermined amount of an extender;
mixing the NDI component and the extender component;
preheating a mold for the polymeric valve insert;
placing a mixture of the NDI component and the extender component in the preheated mold to form the polymeric valve insert;
placing the mold and polymeric valve insert in a pressure press for a predetermined time at predetermined temperature; and
demolding the mold to obtain a demolded polymeric valve insert.

14. The method of claim 13 further including curing the demolded polymeric article for a predetermined time at a predetermined temperature.

15. The method of claim 13 further including adding fibers selected from the group consisting of carbon fibers and ceramic fibers to the naphthalein-1,5-diisocynate (NDI) based polyurethane component before heating the naphthalein-1,5-diisocynate (NDI) based polyurethane component.

16. The method of claim 13 further including adding nanofibers selected from the group consisting of carbon nanotubes and nanometallic fibers to the naphthalein-1,5-diisocynate (NDI) based polyurethane component before heating the naphthalein-1,5-diisocynate (NDI) based polyurethane component.

17. The method of claim 13 further including adding nanoparticles selected from the group consisting of TiO2, platelet nanoclay, and carbon to the naphthalein-1,5-diisocynate (NDI) based polyurethane component before heating the naphthalein-1,5-diisocynate (NDI) based polyurethane component.

18. The method of claim 13 wherein the extender is 1,4-butane diol.

19. The method of claim 13 wherein the NDI based polyurethane component is formed by reacting polyester polyol, polyether polyol or, polycarbonate polyol with NDI.
